(19) United States
(12) Patent Application Publication
(10) Pub. No.: US 2011/0088336 A1
(43) Pub. Date: Apr. 21, 2011

(54) Integrated post and jack system

(76) Inventor: John E. Larsen, JR., Anchorage, AK (US)

(21) Appl. No.: 12/588,512

(22) Filed: Oct. 19, 2009

(51) Int. Cl. B66F 3/24; E04G 23/06

(52) U.S. Cl. 52/126.1; 254/93 R

(57) ABSTRACT

An adjustable leveling system for leveling foundations subject to subsidence and frost heave and is particularly suited for use in permafrost and cold regions as characterized by an adjustable leveling system comprising a base for supporting a hydraulic leveling jack wherein the leveling jack has a hollow support tube mounted thereon and the support tube extends upwardly from the hydraulic jack. A lifting sleeve having a first tube and a second tube wherein said first tube is located within said second tube wherein each of the first and second tubes having at least one wall wherein said at least one wall of said first tube is located within said at least one wall of said second tube and a space is formed between said at least one wall of said first tube and said at least one wall of said second tube wherein the space being of sufficient width so that the support tube is slidably received within said space and the lifting sleeve having a cap at the lower end thereof wherein the hydraulic leveling jack includes a portion that raises and engages the cap.

### FIELD OF THE INVENTION

The present invention relates to an integrated post and jack system for use with leveling building foundations.

### BACKGROUND OF THE INVENTION

Alaska and areas of similar latitude are besieged by permafrost and ice rich soil conditions that affect building foundations by both melting and frost heave causing foundations to tilt. Over time the fluctuations in the soil and permafrost beneath the foundation can cause damage to building structures to the extent the building is unusable. The costs involved in repair of the structure and the foundation can be unsustainable.

Although foundation systems have been designed to solve these problems, they are generally not economically feasible for homes, in particular, as well as many other buildings. The budgets available for the construction of housing is not adequate for the installation of elaborate piling or refrigerated systems used for large commercial structures. In fact, the majority of homeowners living in the permafrost regions of Alaska simply acquiesce to high maintenance and repair costs of their homes caused by foundation movement.

Two types of foundations are typically used for housing and light buildings constructed in areas having permafrost conditions. One is “post and pad” and the other is piling. Although the post and pad system may have many variations, it commonly consists of wood or steel posts designed and supported on treated timber footings. The houses using this system are subject to high vertical and differential movement. The annual freeze-thaw cycles and frost heaves under the pads cause movement resulting in structural stresses to the houses resulting in cracking wallboard, plumbing breaks, broken window seals and doors jamming and in some severe cases, almost total failure of the houses. Most post and pad systems are difficult to adjust once they have moved and trying to re-level the houses has been a major challenge. Similarly, piling systems are subject to frost heave that causes pilings to be jacked upwardly as the frozen ground surface grips the portion of the piling near the ground surface and forces the piling upward.

In view of the foregoing it can be seen that there is a need for an effective and economical integrated post and jack system for building foundations for housing and other buildings in permafrost regions.

### OBJECTS AND SUMMARY OF THE INVENTION

Therefore, it is an object of the invention to provide an integrated post and jack system for leveling foundations.

Another object of the invention is to provide a method for leveling foundations using an integrated post and jacks.

Still another object of the invention is to provide an apparatus for facilitating leveling of an existing building.

Yet another object of the invention is to provide an adjustable leveling system as a long-term contingency so that the house can be re-leveled in the event of vertical movement.

In summary, the invention is directed to an adjustable leveling system for leveling foundations subject to subsidence and frost heave and is particularly suited for use in permafrost and cold regions as characterized by an adjustable leveling system comprising a base for supporting a hydraulic leveling jack wherein the leveling jack has a hollow support tube mounted thereon and the support tube extends upwardly from the hydraulic jack. A lifting sleeve having a first tube and a second tube wherein said first tube is located within said second tube wherein each of the first and second tubes having at least one wall wherein said at least one wall of said first tube is located within said at least one wall of said second tube and a space is formed between said at least one wall of said first tube and said at least one wall of said second tube wherein the space being of sufficient width so that the support tube is slidably received within said space and the lifting sleeve having a cap at the lower end thereof wherein the hydraulic leveling jack includes a portion that raises and engages the cap. Furthermore, the invention is also directed to a building leveling system comprising a plurality of adjustable posts located beneath a bottom floor of a building wherein each post is spaced apart and located so as to support the entire weight of said building and each adjustable posts includes a hydraulic jack, a pair of concentric lifting sleeves and a support sleeve wherein the pair of concentric lifting sleeves are spaced apart a sufficient space to permit said support sleeve to be slidably received within the space and the hydraulic jack is operable to lift the lifting sleeves and the adjustable posts being operable to raise at least a portion of the building.

These and other objects, uses and advantages will be apparent from a reading of the description which follows with reference to the accompanying drawings forming a part thereof.

### BRIEF DESCRIPTION OF THE DRAWINGS

FIG. 1 is a perspective view with portions exploded of one preferred embodiment of the adjustable leveling system;

FIG. 2 is a perspective view of an adjustable post of the adjustable leveling system;

FIG. 3 is a cross-sectional top view of the adjustable post of FIG. 2 taken along lines 3-3;

FIG. 4 is a side view of an adjustable post in the non-extended position;

FIG. 5 is a side view of the adjustable post in the extended position; and,

FIG. 6 is perspective view of an adjustable post having a base connected thereto.

### DETAILED DESCRIPTION OF THE PREFERRED EMBODIMENT

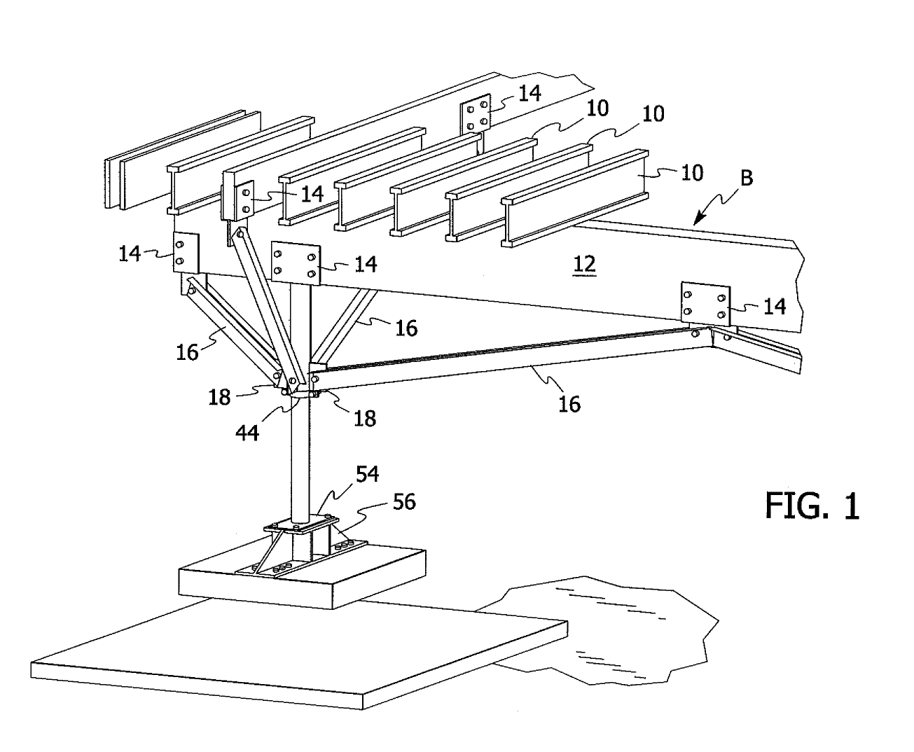

FIG. 1 shows a building B having a plurality of floor joists 10 supported by beam 12. The adjustable leveling system S as shown in FIG. 1 preferably includes attachment flanges 14 for connection to either or both the floor joists 10 or the support beam 12. The flanges 14 may be L-shaped or U-shaped and are preferably bolted to the joists 10 or support beam 12. Braces 16 are attached to the flanges 14 and extend to the adjustable post 20. Braces 16 are preferably angle iron or L-shaped steel and are bolted at one end to one of the flanges and at the other end to the brace connectors 18 of the adjustable post 20. Attachment flanges 14, braces 16 as well as the adjustable post 20 are preferably formed of steel or similar high strength materials.

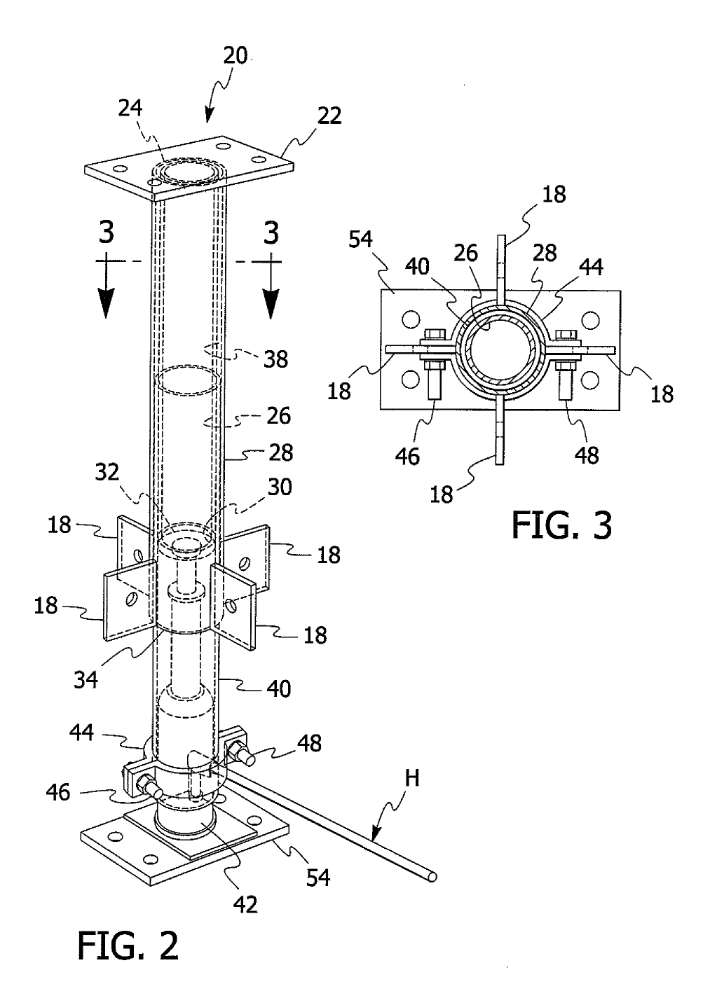

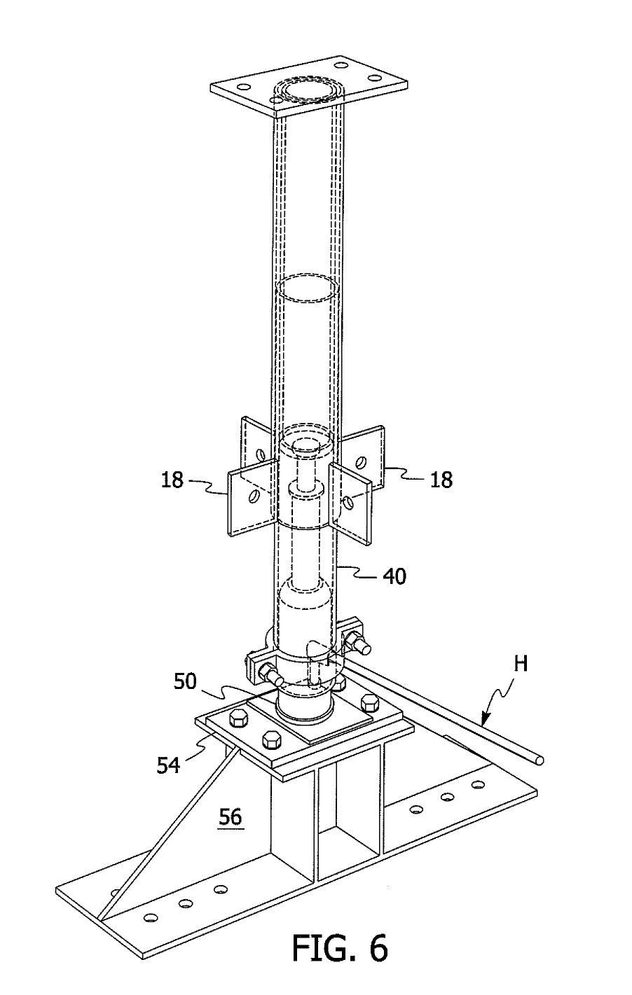

Now with reference to FIG. 2, the adjustable post 20 preferably includes a top plate 22, preferably about ½ inch thick and 6 inches wide by 12 inches long although the size of the plate may vary according to the particular requirements of the job. Top plate 22 is securely connected, preferably by welding to the top end 24 of a concentric elongated sleeve 28. Sleeves 26 and 28 are shown as circular cylinders, but the exterior shape could also be rectangular or square. Sleeve 26 forms an inner sleeve lift cylinder of preferably about 3 inches in outside diameter and constructed of preferably 0.6 inch thick steel and is about 26.27 inches in length and has a second end 30 capped with a ½ inch thick bearing plate 32. Outer sleeve 28 is preferably formed of steel of about 0.474 inch thickness and 4 inches in outside diameter and about 28 inches in length and has a second end 34 which includes preferably four brace connectors 36 extending outwardly therefrom. Of course, more or less brace connectors 36 could be used. Inner sleeve 26 and outer sleeve 28 are spaced sufficiently that a gap 38 is formed of a width to accommodate a support sleeve 40. Support sleeve 40 is preferably has an outside diameter of about 4 inches and is about 0.452 inches in thickness with a length of about 26 inches and is mounted to a hydraulic jack 42. It should be understood that the lengths of the sleeve 26, 28 and 40 may be either longer or shorter in length depending on the particular application. Preferably, a compression ring 44 having connecting bolts 46 and 48 is placed around the support sleeve 40 and fixed in place just below the second end 34 to support the outer sleeve 28 after the beam 12 and braces 16 have been raised to by the hydraulic jack 42. Hydraulic jack 42 is preferably a 6-ton Norco Model 76508 hydraulic bottle jack, but a larger or smaller jack may be substituted depending on the particular job. The hydraulic jack 42 is typically operated by pumping a handle H. Preferably the hydraulic jack 42 is also welded to the support sleeve 40. As shown in FIG. 6, the base 50 of the hydraulic jack 42 is also preferably welded to a base plate 54 which is preferably bolted to a support base 56.

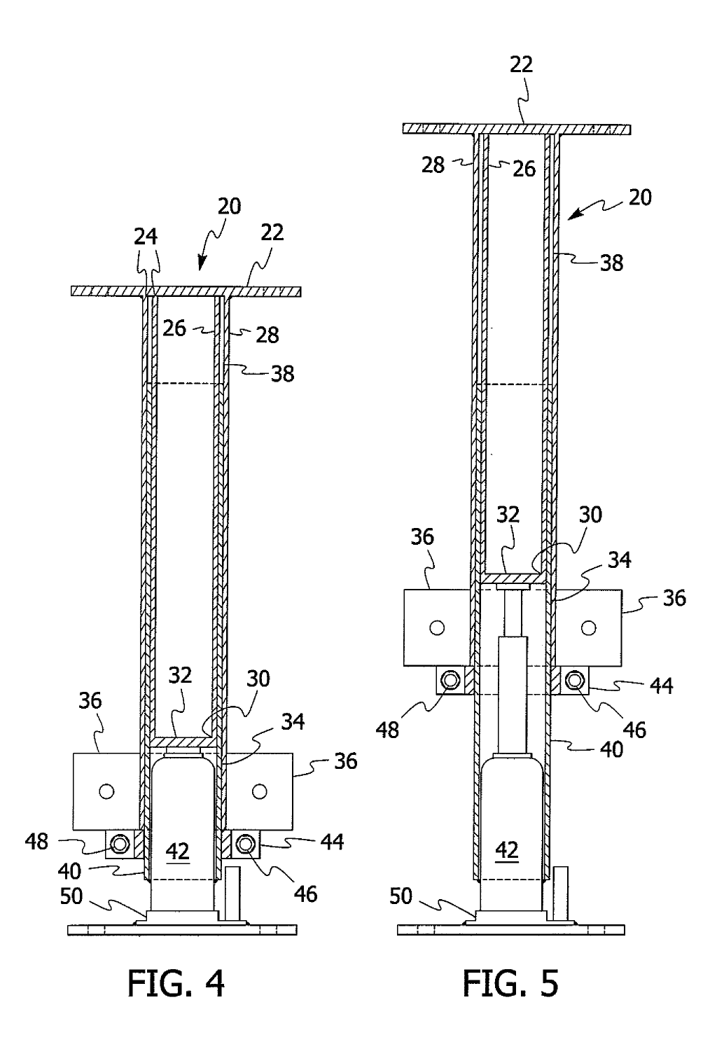

Now the operation of the leveling jack system will be described with reference to FIGS. 1, 4 and 5. In FIG. 4, the adjustable post 20 is shown with the hydraulic jack 42 in its retracted position. As shown in FIG. 5, the hydraulic jack 42 is extended to exert an upward force on bearing plate 32 and sleeves 26 and 28 slide upwardly relative to support sleeve 40. Top plate 22 pushes upwardly on the beam 12 and braces 16 are also raised as the connectors 36 are lifted with outer sleeve 28. For a typical 1200 square foot building eight adjustable posts 20 would be used.

It should be understood that a plurality of adjustable leveling systems S may be used in a particular building and may be spaced beneath the bottom floor of the building to support the entire weight of the building. Furthermore, the adjustable posts 20 may be used without additional bracing. Once the adjustable leveling system S is installed, it can be positioned so that it can remain in place to level the building as needed.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

I claim:

1. An adjustable leveling system comprising:
a) a base for supporting a hydraulic leveling jack;
b) said leveling jack having a hollow support tube mounted thereon;
c) said support tube extending upwardly from said hydraulic jack;
d) a lifting sleeve having a first tube and a second tube wherein said first tube is located within said second tube;
e) each of said first and second tubes having at least one wall wherein said at least one wall of said first tube is located within said at least one wall of said second tube and a space is formed between said at least one wall of said first tube and said at least one wall of said second tube;
f) said space being of sufficient width so that said support tube is slidably received within said space;
g) said lifting sleeve having a cap at the lower end thereof;
h) wherein said hydraulic leveling jack includes a portion that raises and engages said cap.

2. The adjustable leveling system as set forth in claim 1, wherein:
a) said first tube and said second tube each having a top end;
b) a plate attached to said first tube and said second tube at said top ends.

3. The adjustable leveling system as set forth in claim 1, wherein:
a) a compression ring is mounted on said support tube and positioned just below said second tube to support said lifting sleeve.

4. The adjustable leveling system as set forth in claim 1, wherein:
a) said hydraulic jack is a hydraulic bottle jack.

5. The adjustable leveling system as set forth in claim 1, wherein:
a) said second tube having a plurality of brace connectors connected thereto for attaching a plurality of braces thereto.

6. The adjustable leveling system as set forth in claim 5, wherein:
a) said plurality of braces extend outwardly and upwardly from said brace connectors and engage attachment flanges;
b) each of said attachment flanges connect to a floor joist.

7. The adjustable leveling system as set forth in claim 5, wherein:
a) at least one of said plurality of braces extends outwardly and upwardly from at least one of said brace connectors and engages a support beam.

8. The adjustable leveling system as set forth in claim 1, wherein:
a) said hydraulic jack is supported by a base plate.

9. The adjustable leveling system as set forth in claim 8, wherein:
a) said base plate is mounted to a support base.

10. A building leveling system comprising:
a) a plurality of adjustable posts located beneath a bottom floor of a building;
b) each of said posts being spaced apart and located so as to support the entire weight of said building;
c) each of said adjustable posts including a hydraulic jack, a pair of concentric lifting sleeves and a support sleeve;
d) said pair of concentric lifting sleeves being spaced apart a sufficient space to permit said support sleeve to be slidably received within said space;
e) said hydraulic jack being operable to lift said lifting sleeves and said adjustable posts being operable to raise at least a portion of said building.

11. The building leveling system as set forth in claim 10, wherein;
a) said pair of lifting sleeves each having a top end;
b) a plate attached to said lifting sleeves at said top ends.

12. The building leveling system as set forth in claim 10, wherein;
a) a compression ring is mounted on said support sleevetube and positioned to support said lifting sleeve.

13. The building leveling system as set forth in claim 10, wherein;
a) said hydraulic jack is a six ton jack.

14. The building leveling system as set forth in claim 10, wherein;
a) said lifting sleeves having a plurality of brace connectors connected thereto for attaching a plurality of braces thereto.

15. The building leveling system as set forth in claim 14, wherein;
a) said plurality of braces extend outwardly and upwardly from said brace connectors and engage attachment flanges;
b) each of said attachment flanges connect to a floor joist.

16. The building leveling system as set forth in claim 14, wherein;
a) at least one of said plurality of braces extends outwardly and upwardly from at least one of said brace connectors and engages a support beam.

17. The building leveling system as set forth in claim 10, wherein;
a) said hydraulic jack is supported by a base plate.

18. The building leveling system as set forth in claim 10, wherein;
a) said base plate is mounted to a support base.
